(19) United States
(12) Patent Application Publication
(10) Pub. No.: US 2019/0040833 A1
(43) Pub. Date: Feb. 7, 2019

(54) STARTER DEVICE AND DRIVE TRAIN WITH A STARTER DEVICE

(71) Applicant: ZF Friedrichshafen AG, Friedrichshafen (DE)

(72) Inventors: Martin RUIDER, Schwarzhofen (DE); Michael IBELE, Ravensburg (DE)

(73) Assignee: ZF Friedrichshafen AG, Friedrichshafen (DE)

(21) Appl. No.: 16/045,963

(22) Filed: Jul. 26, 2018

(30) Foreign Application Priority Data
Aug. 1, 2017 (DE) DE102017213225.6

(51) Int. Cl. F02N 15/02; F02N 15/04; F02N 5/04; F02N 11/08; B60K 6/38; B60K 6/40; F16H 25/12; F16D 23/12

(52) U.S. Cl. CPC F02N 15/025; F02N 15/04; F02N 5/04; F02N 11/0862; B60K 6/38; F16H 1/16; F16H 25/125; F16D 23/12; B60Y 2300/436; B60Y 2200/92; F16D 2023/123; B60K 6/40

(57) ABSTRACT

A starter apparatus is provided for starting a combustion engine of a hybrid vehicle, wherein an energy accumulator, a switching element for optionally coupling the energy accumulator with the combustion engine and a drive unit for driving the energy accumulator and for actuating the switching element. Also claimed is a drive train with the proposed starter apparatus.

### FIELD

The present disclosure relates to a starter apparatus for starting a combustion engine according to the type described in more detail herein. Furthermore, the disclosure relates to a drive train of a hybrid vehicle with the starter apparatus for starting or additionally starting the combustion engine.

### BACKGROUND

Hybrid vehicles are well-known in automotive technology. Usually, a hybrid vehicle has a combustion engine as first drive and an electric motor as second drive, which is supplied with energy by a battery. The combustion engine and/or the electric motor drive the output of the vehicle via a transmission. During combustion engine operation, the battery is charged by the electric motor acting as a generator. In other driving situations, the battery supplies the electric motor with energy, enabling functions such as purely electric driving, sailing or electric boosting of the combustion engine. To implement these functions, the combustion engine must be able to be started when stationary and during purely electric travel. In the case of known hybrid vehicle drive trains, this starting process is carried out by a starter apparatus, such as a belt starter or the electric motor of the hybrid vehicle.

However, it has been shown that during purely electric travel the electric motor is already operated at its power limit, so that there are no power reserves for starting the combustion engine. If the electric motor is overexcited, this can result in a drop in the power supply and an undesired failure of the electronics. Furthermore, belt starters are disadvantageous because they have a complex design and require considerable installation space.

The present disclosure is based on the objective of providing a starter apparatus and a drive train with the starter apparatus of the type described above, in which starting or additionally starting the combustion engine is reliably and cost-effectively implemented in a space-saving manner.

### SUMMARY

According to the disclosure, this objective is achieved by the characteristics of the claims, with advantageous and claimed further developments are included in the respective sub-claims and the description, as well as the drawings.

Thus, we propose a starter apparatus and a drive train of a hybrid vehicle with the starter apparatus for starting or additionally starting a combustion engine. To implement a reliable, safe and cost-effective starting possibility, it is provided that the starter apparatus can be optionally coupled with the combustion engine or is arranged in parallel to the drive train and comprises at least one energy accumulator, a switching element and a drive unit for supplying the energy accumulator and for actuating the switching element.

In this way, a starter apparatus connected in parallel to the combustion engine is preferably implemented between the combustion engine and the starting clutch. The optionally connected energy accumulator, for example, as flywheel mass or inertia, has the advantage that only the starting torque for starting the combustion engine has to be applied or transmitted and not the complete load during full hybrid travel, as is required with conventional serial starter systems. Furthermore, the drive unit, which drives both the energy accumulator and the switching element, provides a cost-effective and space-saving solution. The proposed starter apparatus can also significantly increase the efficiency of the proposed drive train.

An advantageous further development of the present disclosure provides for a first rotational direction of the drive unit to drive the energy accumulator, which is configured, for example, in the form of a rotating flywheel and a second rotational direction of the drive unit to actuate the switching element. As a result, the drive unit of the starter apparatus has a dual function: on the one hand to implement the coupling between starter apparatus or energy accumulator and combustion engine and, on the other hand, to drive the energy accumulator or the flywheel mass to be able to apply the required starting torque. Preferably, the frictional connection between the energy accumulator or flywheel mass and the combustion engine is implemented in two predetermined driving situations. On the one hand, when the combustion engine is uncoupled from the drive train to enable electric driving. In this situation, the flywheel mass is accelerated via the frictional connection by the outgoing combustion engine. As a result, the energy of the phasing out combustion engine is reused. On the other hand, the energy accumulator is coupled to the combustion engine when the combustion engine is to be started. Here the energy of the rotating flywheel mass is used to start the combustion engine. However, the energy of the combustion engine is only sufficient to accelerate the flywheel mass initially. During a sustained electric drive, the energy accumulator or the flywheel mass is therefore accelerated by the electric drive unit. A particular advantage of these two drive unit functions is that only a small electric motor is required for the disclosed starter apparatus.

The use of the two rotational directions of the drive unit for different functions, namely, on the one hand, for actuating the switching element and, on the other hand, for driving the energy accumulator or the flywheel mass, is according to a further development implemented constructively in the starter apparatus by the drive unit being connected with a freewheel shaft, to which a first freewheel and a second freewheel are assigned, which are counter-rotating. This means that only one output of the freewheels is activated in each rotational direction of the freewheel shaft. As a result, only one of the freewheels respectively transmits a torque.

To actuate the switching element via the drive unit, it is necessary to convert the rotary motion of the drive unit to an axial movement. With the proposed starter apparatus, this is achieved by means of a cam disc or the like assigned to the freewheel shaft, which cam disc is driven via one of the freewheels. The rotary motion of the cam disc generates an axial movement so that one of the end faces of the cam disc is brought into frictional engagement with a clutch disc of the switching element to create a connection between the flywheel and the combustion engine.

Preferably, the proposed starter apparatus is used for a hybrid vehicle drive train that is also claimed. A simple and space-saving solution provides that the starter apparatus is placed in a transmission housing of the hybrid vehicle. Preferably, it is placed in the clutch bell of the transmission housing, i.e. on the driving side of the transmission housing facing the combustion engine.

### BRIEF DESCRIPTION OF THE DRAWINGS

The disclosure is described in more detail by means of the drawings. It is shown:

FIG. 1 shows a schematic view of a first embodiment of a drive train of a hybrid vehicle with a starter apparatus;

FIG. 2 shows a schematic view of a second embodiment of the drive train with an alternative arrangement of the starter apparatus;

FIG. 3 shows a sectional partial view of the drive train according to FIG. 1;

FIG. 4 shows a schematic sectional view of the starter apparatus with a free-wheel shaft having a first freewheel and a second freewheel and driven by a drive unit;

FIG. 5 shows a schematic three-dimensional view of the drive unit of the starter apparatus with a cam disc;

FIGS. 6 and 6A shows schematic views of individual parts of the cam disc;

FIG. 7 shows a schematic top view of the starter apparatus; and

FIG. 8 shows a schematic sectional view of the starter apparatus.

FIGS. 1 to 8 show different exemplary views of a disclosed starter apparatus and a disclosed drive train of a hybrid vehicle with the starter apparatus 1.

### DETAILED DESCRIPTION OF EXAMPLE EMBODIMENTS

Independent of the respective embodiments, it is provided that starter apparatus 1 for starting the combustion engine VM is arranged or can be switched parallel to the drive train and comprises an energy accumulator indicated to be a rotating flywheel mass 2, a switching element KS and a drive unit 3 for driving the flywheel mass 2 and for actuating the switching element KS.

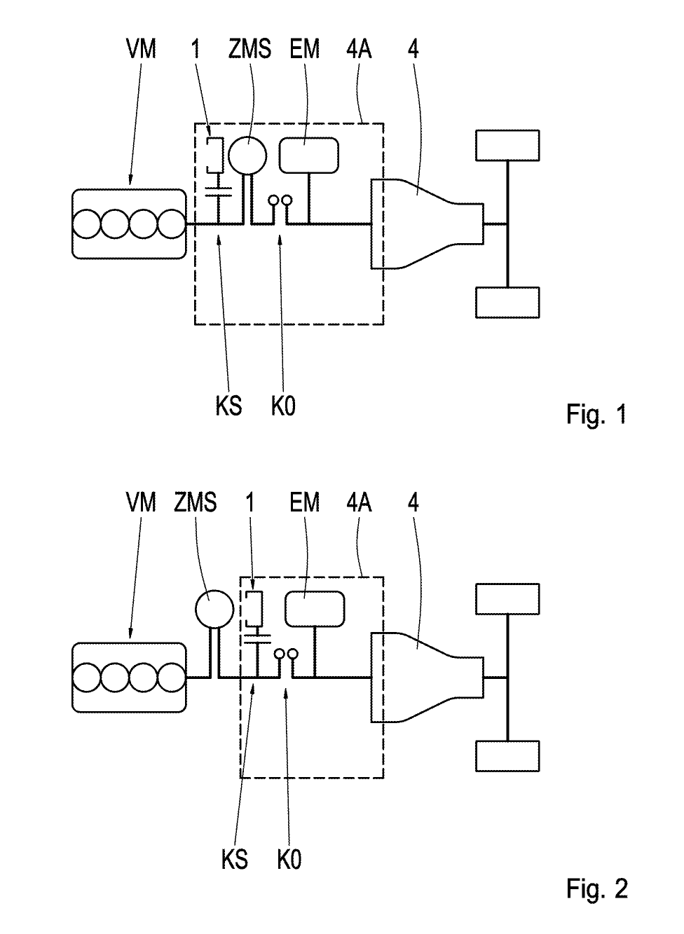

FIG. 1 shows a first embodiment of the drive train, in which the starter apparatus 1 is arranged behind the combustion engine VM and in front of a vibration damper configured in the form of a dual mass flywheel ZMS. FIG. 2 shows a second embodiment, in which the starter apparatus 1 is arranged behind the combustion engine VM and the dual mass flywheel ZMS in the drive train of the hybrid vehicle.

Independent of the various embodiments, the starter apparatus 1 is located on the drive side in a transmission housing 4 of the hybrid vehicle, in particular in the clutch bell 4A of the transmission housing 4 and is located in front of the starting clutch K0 and the electric motor EM of the hybrid vehicle. The flywheel mass 2 of starter apparatus 1 can be connected either directly or indirectly with the drive shaft of the combustion engine VM via switching element KS to transmit the starting torque from the flywheel mass 2 for starting or additionally starting the combustion engine VM.

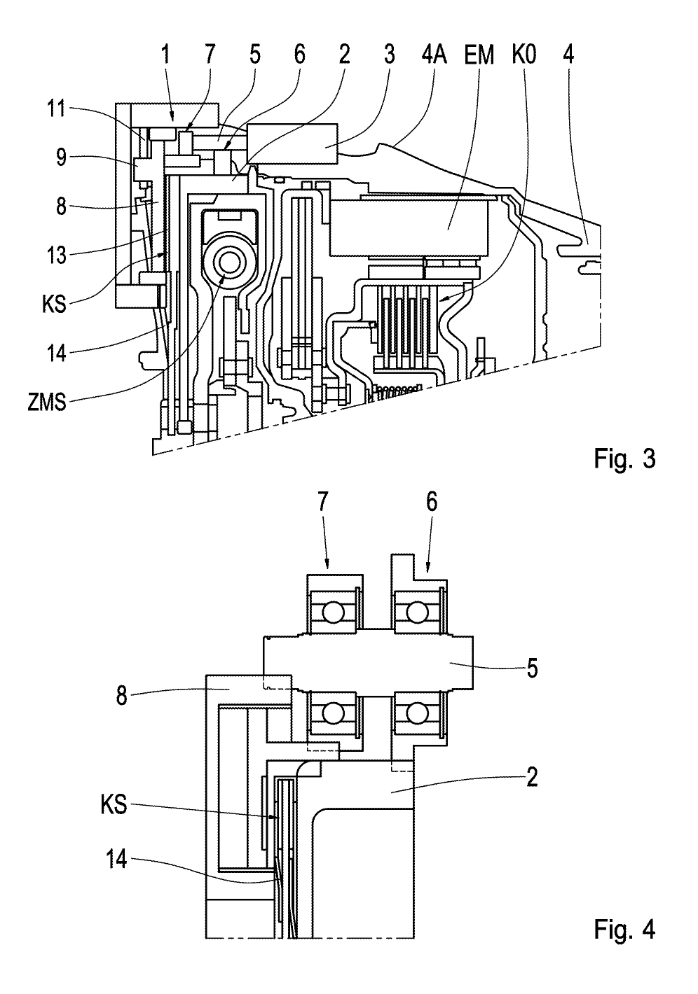

As shown especially in FIG. 3, a small electric motor is provided as drive unit 3, which applies only the starting torque and is connected to a freewheel shaft 5. The freewheel shaft 5 has a first freewheel 6 and a second freewheel 7. As a result, a first rotational direction of the freewheel shaft or of the drive unit 3 via the first freewheel 6 is used to drive the energy accumulator configured in the form of a rotating flywheel mass 2, while a second rotational direction of the freewheel shaft 5 via the second freewheel 7 is used to actuate the switching element KS. The first freewheel 6 and the second freewheel 7 are counter-rotating. As a result, the output of the first freewheel 6 is used to drive the flywheel mass 2, while the output of the second freewheel 7 is used to drive the cam disc 8 and thus establish the frictional connection by closing the switching element KS, the output of the second freewheel 7 acting in the opposite rotational direction with respect to the output of the first freewheel 6. This allows the motor or drive unit 3 to perform two functions, since a first rotational direction of the drive unit 3 accelerates the flywheel mass 2 and a second rotational direction of the drive unit 3 actuates the cam disc 8.

FIG. 4 shows a detailed view of the freewheel shaft 5 with the first freewheel 6 and the second freewheel 7. Via the first freewheel 6, the flywheel mass 2 is accelerated via the drive device 3 by means of a tooth system, while the second freewheel 7 drives the cam disc 8, the rotary motion of which can be converted into an axial movement for actuating a clutch disc via a pressure plate 13 of the switching element KS against a return element configured in the form of a membrane spring 14.

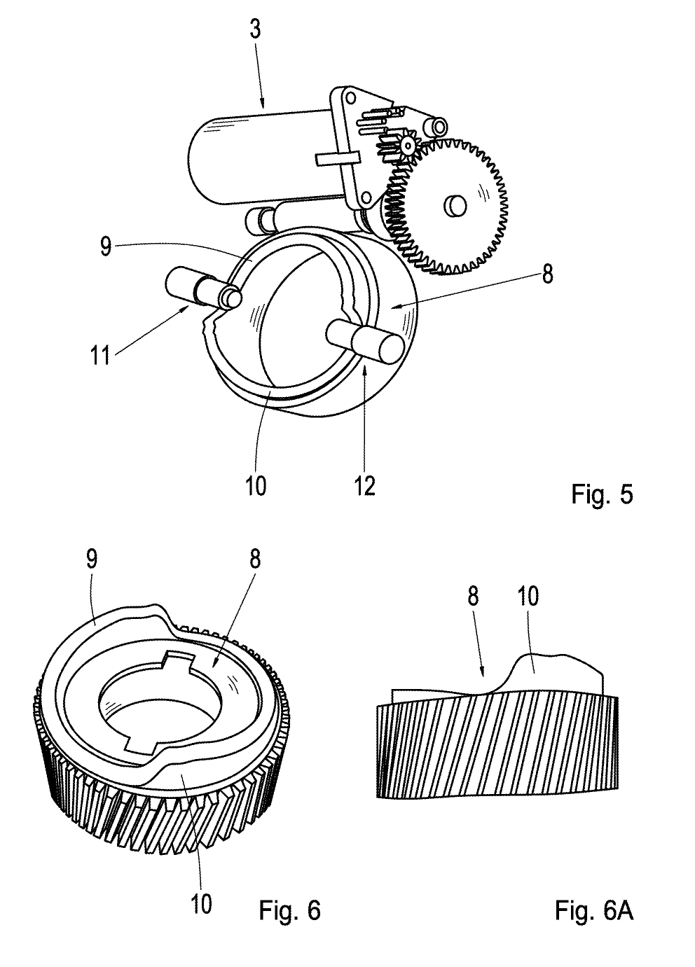

FIG. 5 shows the drive unit 3 with cam disc 8 in more detail. This representation shows an alternative drive option for the cam disc 8, in which the cam disc 8 is set in rotation by the drive unit 3 via a worm gear in the area of the second freewheel 7. By way of contrast, in the embodiment according to FIG. 4, the cam disc 8 is driven by an internal tooth system. Independent of the respective drive option provided, the cam disc 8 has splitter paths 9, 10 on the end face facing away from the switching element KS for converting the rotary motion to an axial movement. The respective splitter paths 9, 10 extend over half the circumference of the cam disc 8. In the non-actuated starting position of the switching element KS, a plunger 11, 12 fixed to the housing is assigned to the beginning of the respective splitter path. The plunger 11, 12, which is fixed to the housing, rolls along the splitter paths 9, 10 during the rotary motion of the cam disc 8, so that the rotation of cam disc 8 is converted to an axial movement, depending on the increase of the splitter paths 9, 10, to press the end face facing the switching element KS against the clutch disc of the switching element KS. This generates a frictional connection to couple the flywheel mass 2 with the combustion engine VM.

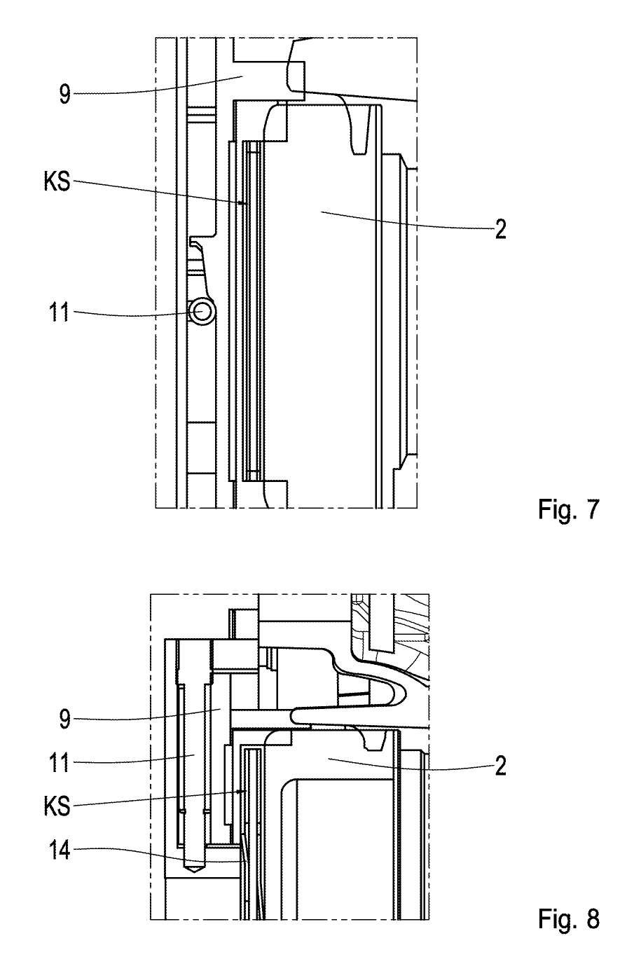

FIGS. 7 and 8 show further detailed views of starter apparatus 1 with cam disc 8 and switching element KS for generating the frictional connection between the flywheel mass 2 and the combustion engine VM. FIG. 7 shows a top view of the schematic view and FIG. 8 shows a schematic section.

In the drive train proposed in the disclosure, the starter apparatus 1 prevents the flywheel mass 2 from constantly accelerating and braking due to the parallel connection, so that the overall inertia in the drive train is reduced. Furthermore, the flywheel mass 2 can be accelerated when the combustion engine VM is phasing out when starting the electric drive and thus the remaining energy of the combustion engine VM can be used. Then, the desired rotational speed of the flywheel mass 2, which corresponds to the starting torque for starting or additionally starting the combustion engine VM, can be maintained by means of a low energy input of the drive unit 3.

### REFERENCE NUMERALS

1 Starter apparatus
2 Flywheel mass
3 Drive unit
4 Transmission housing
4A Clutch bell
5 Freewheel shaft
6 First freewheel
7 Second freewheel
8 Cam disc
9 Splitter path
10 Splitter path
11 Plunger fixed to the housing
12 Plunger fixed to the housing
13 Pressure plate
14 Return element of the switching element KS configured in the form of a membrane spring
VM Combustion engine as first drive of the hybrid vehicle
EM Electric motor as second drive of the hybrid vehicle
K0 Starting clutch
KS Switching element for connecting flywheel mass and combustion engine
ZMS Vibration damper configured in the form of a dual mass flywheel

1. A starter apparatus for starting a combustion engine of a hybrid vehicle, comprising:
an energy accumulator,
a switching element for optionally connecting the energy accumulator with the combustion engine; and
a drive unit for driving the energy accumulator and for actuating the switching element.

2. The starter apparatus according to claim 1, wherein a first rotational direction of the drive unit is configured to drive the energy accumulator and a second rotational direction of the drive unit is configured to actuate the switching element.

3. The starter apparatus according to claim 1, wherein the drive unit is connected with a freewheel shaft, to which a first freewheel and a second freewheel are assigned, wherein the first freewheel and the second freewheel are counter-rotating.

4. The starter apparatus according to claim 3, wherein the freewheel shaft is coupled via the first freewheel with the energy accumulator and via the second freewheel with the switching element.

5. The starter apparatus according to claim 3, wherein a cam disc can be driven via the second freewheel, and the rotary motion of the cam disc is configured to be converted into an axial movement for actuating a clutch disc of the switching element.

6. The starter apparatus according to claim 5, wherein the rotating cam disc has a first splitter path and a second splitter path on an end face of the cam disc facing away from the switching element for converting the rotary motion of the cam disc to an axial movement to establish a frictional connection with a clutch disc of the switching element, and each of the splitter paths is assigned to a plunger, wherein each plunger is fixed to the housing.

7. A drive train of a hybrid vehicle with a starter apparatus according to claim 1.

8. The drive train according to claim 7, further comprising a combustion engine, wherein after the combustion engine has been switched off, the energy accumulator of the starter apparatus can be coupled with a drive shaft of the combustion engine for transmitting rotational energy of the combustion engine to the energy accumulator, and the energy accumulator can be driven via the drive unit after the energy accumulator has been decoupled from the drive shaft of the combustion engine.

9. The drive train according to claim 7, wherein the starter apparatus is arranged on the drive side in a clutch bell of a transmission housing of the hybrid vehicle.

10. The drive train according to claim 1, wherein the energy accumulator of the starter apparatus can be connected either directly or indirectly with the drive shaft of a combustion engine.

11. The starter apparatus according to claim 2, wherein the energy accumulator is a rotating flywheel.

12. The starter apparatus according to claim 5, wherein the axial movement actuates the clutch disc via a pressure plate of the switching element against a return element.

13. The starter apparatus according to claim 12, wherein the return element is a membrane spring.

14. The starter apparatus according to claim 5, wherein the cam disc is rotated by the drive unit via a worm gear.

15. The starter apparatus according to claim 5, wherein the cam disc is rotated by the drive unit via an internal tooth system.

16. The starter apparatus according to claim 4, wherein the energy accumulator is coupled to first freewheel by a tooth system.

17. The starter apparatus according to claim 6, wherein the first splitter path and the second splitter path each extend over half the circumference of the cam disc.

18. A method of operating a starter apparatus, the method comprising the steps of:
rotating a freewheel shaft in a first direction, wherein the freewheel shaft is coupled to a drive unit,
accelerating an energy accumulator via a first freewheel in response to rotating the freewheel shaft in the first direction,
rotating the freewheel shaft in a second direction,
actuating a switching element via a second freewheel in response to rotating the freewheel shaft in the second direction.

19. The method of claim 18, further comprising the step of connecting a combustion engine to the freewheel shaft through a frictional engagement with a clutch disc of the switching element and through the second freewheel when the freewheel shaft is rotated in the second direction.

20. The method of claim 18, further comprising the step of rotating the freewheel shaft in the second direction with energy provided by the energy accumulator.
